(19) United States
(12) Patent Application Publication
(10) Pub. No.: US 2003/0172011 A1
(43) Pub. Date: Sep. 11, 2003

(54) Material joint purchase system, material joint purchase method, and program for making a computer perform this method

(75) Inventors: Susumu Takahashi, Tokyo (JP); Noriyoshi Mitsudome, Tokyo (JP); Kazuharu Maeda, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/378,799

(22) Filed: Mar. 4, 2003

(30) Foreign Application Priority Data
Mar. 5, 2002 (JP) 2002-059433

(51) Int. Cl. G06F 17/60

(52) U.S. Cl. 705/29; 705/1

(57) ABSTRACT

A material joint purchase system comprises a contract information collecting means 44 for collecting contract information related to material purchase contracts which each of material purchasing companies has with said material suppliers, a contract information storing means 53 for storing the collected contract information according to the kind of material being a contract object, a contract information presenting means 47 for presenting stored contract information to said terminal 2A, 2B or 2C in response to material purchase offering information outputted from said terminal 2A, 2B or 2C, a contract selecting information receiving means 46 for receiving contract selecting information selected out of presented contract information, and a purchase offering information reporting means 48 for reporting said purchase offering information to terminal 2A, 2b or 2C of a material purchasing company having a material purchase contract related to the received contract selecting information.

### BACKGROUND OF THE INVENTION

1. Field of the Invention

The present invention relates to a material joint purchase system provided with terminals respectively possessed by a plurality of material purchasing companies, enabling the plurality of material purchasing companies to jointly purchase materials from material suppliers, a material joint purchase method, and a program for making a computer perform this method.

2. Related Art

In the manufacturing industry, a manufacturer makes a profit in general by purchasing materials to be raw materials from material suppliers, so-called suppliers, processing the materials to make products with added values and selling the products.

Among such manufacturers, a company manufacturing machines and other functional products must purchase various materials from many suppliers since its products each are often composed of many components. For example, a manufacturer of construction machinery and the like must purchase various materials such as steel materials for forming the body of a construction machine, hydraulic oil of a working machine, welding rods to be used in welding for joining steel materials with each other, paints for armor-painting a construction machine and the like.

Up to now, each enterprise has made a material purchase contract with each supplier, and the purchase of such materials has been performed on the basis of unit prices, transaction units and the like determined by the contract.

However, such a contract made by each enterprise is based on the amount of material to be used within the enterprise, and since a supplier cannot pay unless it makes a unit price higher when a sufficient amount of transactions are not definitely promised, the supplier must determine a unit price in contract according to the amount of transactions of the enterprise purchasing the material.

That is to say, in enterprises purchasing materials, in case that different enterprises purchase the same kind of material from a supplier, the respective enterprises may be different in amount of material to be purchased, for example, company A has a lower unit price determined by contract on condition of large-amount purchase thanks to using a large amount of welding rods, while company B results in having a higher unit price due to a less amount of material used.

### SUMMARY OF THE INVENTION

An object of the present invention is to provide a material joint purchase system, a material joint purchase method and a program for making a computer perform this method, which enable each of plural material purchasing companies to purchase a material at the lowest cost from a material supplier being a supplier which the material purchasing company has a contract with.

The present invention attains the above-mentioned object in that each of plural material purchasing companies discloses information of a contract which it has with each material supplier on the World Wide Web and purchases materials utilizing the purchase route of a material purchase company having a purchasing contract being the lowest in price. For this purpose, the present invention comprises the following composition.

A material joint purchase system of the present invention is characterized by a material joint purchase system provided with terminals respectively possessed by a plurality of material purchasing companies and a server connected to each of the terminals through a network and enabling the plurality of material purchasing companies to jointly purchase materials from material suppliers, said system comprising a contract information collecting means for collecting contract information related to a material purchase contract which each of the material purchasing companies has with said material supplier, a contract information storing means for storing the collected contract information according to the kind of material to be a contract object, a contract information presenting means for presenting stored contract information to a terminal in response to material purchase offering information outputted from said terminal, a contract selecting information receiving means for receiving contract selecting information selected out of presented contract information, and a purchase offering information reporting means for reporting said purchase offering information to a terminal of a material purchasing company having a material purchase contract related to the received contract selecting information.

According to the present invention as described above, contract information related to a material purchase contract which each material purchasing company has with a material supplier is collected by a contract information collecting means and the collected contract information is stored by a contract information storing means according to the kind of a material, when purchase offering information of a material is outputted from a terminal of a material purchasing company, the contract information in response to this is presented to the said terminal. And the contract selecting information selected out of presented contract information is received by a contract selecting information receiving means and a terminal of a material purchasing company having a material purchase contract related to the contract selecting information is notified of the purchase offering information by a purchase offering information reporting means, and thereby the invention enables the material purchasing company to perform a material ordering operation including its purchase offering and enables the material purchasing company which has outputted the purchase offering information to purchase the material at the lowest price.

And since a material supplier such as a supplier and the like also can receive an order of materials in bulk, it can simplify an order receiving operation and a delivery operation, and thereby, can efficiently sell and supply materials.

A material joint purchase system of the present invention preferably comprises a contract information update means for collecting information related to change in a material purchase contract on the basis of a result of material transactions of a material purchasing company notified of purchase offering information and updating stored contract information.

According the invention like this, since the amount of material ordered by a material purchasing company having a material purchase contract selected from contract selecting information is increased, it is possible to change the contract so as to reduce the unit price of the material due to scale merit. And since it is possible to always provide information about the lowest unit price of a material on the World Wide Web by collecting information related to a contract change by means of the contract information update means, it is possible to realize transactions more advantageous to participating material purchasing companies.

In a material joint purchase system of the present invention, it is preferable that contract information stored in a contract information storing means includes at least the item number, the price and the place of delivery of a material.

Here, the item number of a material means an item number determined by a supplier to be a material supplier. The reason is that it is an item number being able to be dealt with commonly by plural material purchasing companies.

According the invention like this, since it is possible to present information about the item number, the price and the place of delivery of a material to a terminal of a material purchasing company wishing to purchase it, it is possible to confirm the kind, item number, price and place of delivery of the material which the company requests to purchase, and then properly select contract information related the material meeting the request.

In a material joint purchase system of the present invention, in case that each terminal is connected to a material management information storing means storing in it material management information of the respective material purchasing companies, it is desirable that each terminal comprises a material management information output means for outputting material management information stored in the material management information storing means to said server.

Here, material management information includes also contract information related to a material purchase contract in addition to actual result information of material purchase.

According to the invention like this, since the server can automatically collect contract information of a material purchasing company participating in the system on the basis of material management information of the material purchasing company, it is possible to manage information including a contract change related to various materials to be purchased by means of a contract information storing means and jointly purchase materials in a more proper state on the basis of the latest information.

A material joint purchase method of the present invention is obtained by forming a material joint purchase system of the present invention described above into the invention of a method.

A program of the present invention is obtained by forming a material joint purchase method of the present invention described above into a program making a computer perform said method.

Here, the respective steps forming the invention of the method do not have to be performed in the same computer, but a plurality of computers may cooperate with one another to perform a sequence of steps, and furthermore, one step may be performed by a plurality of cooperating computers.

And these inventions also may be limited in the same way as the above-described material joint purchase system of the present invention, and can have the same action and same effect.

And since forming the present invention into a program enables a general-purpose computer to perform a method of the present invention, it is possible to widely spread the invention.

### BRIEF DESCRIPTION OF THE DRAWINGS

FIG. 1 is a schematic diagram showing a business model of a material joint purchase system according to an embodiment of the present invention.

FIG. 2 is a schematic diagram showing the configuration of a material joint purchase system according to an embodiment of the present invention.

FIG. 3 is a schematic diagram showing the structure of a server forming a system according to an embodiment of the present invention.

FIG. 4 is a schematic diagram showing the structure of a client master registration database according to an embodiment of the present invention.

FIG. 5 is a schematic diagram showing the structure of a supplier master registration database according to an embodiment of the present invention.

FIG. 6 is a schematic diagram showing the structure of an article master registration database according to an embodiment of the present invention.

FIG. 7 is a flowchart for explaining operation of an embodiment of the present invention.

FIG. 8 is a flowchart for explaining operation of an embodiment of the present invention.

FIG. 9 is a display screen example for registering client information in an embodiment of the present invention.

FIG. 10 is a display screen example for registering supplier information in an embodiment of the present invention.

FIG. 11 is a display screen example for registering article information in an embodiment of the present invention.

FIG. 12 is a flowchart for explaining operation of an embodiment of the present invention.

FIG. 13 is a flowchart for explaining operation of an embodiment of the present invention.

FIG. 14 is a display screen example for generating purchase offering information in an embodiment of the present invention.

FIG. 15 is a display screen example for generating purchase offering information in an embodiment of the present invention.

FIG. 16 is a display screen example showing a list of contract information presented by a contract information presenting means according to an embodiment of the present invention.

FIG. 17 is a display screen example for generating an estimate request for selected contract information in an embodiment of the present invention.

FIG. 18 is a flowchart for explaining operation of an embodiment of the present invention.

### DETAILED DESCRIPTION OF THE PREFERRED EMBODIMENT(S)

An embodiment of the present invention is described with reference to the drawings in the following.

[Business Model and Configuration of System]

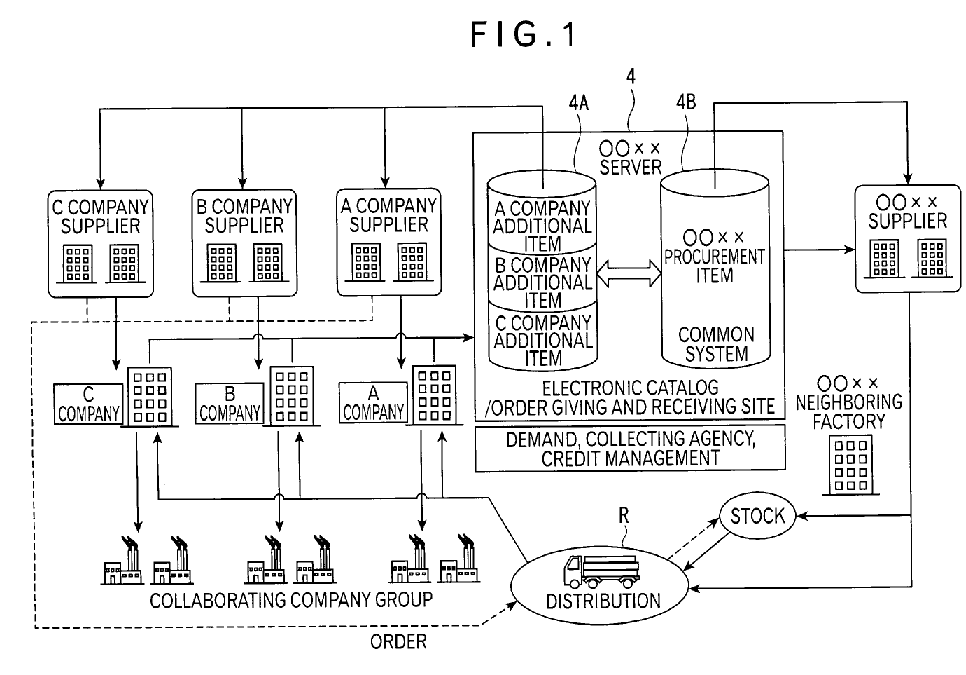

FIG. 1 is a schematic diagram showing a business model of a material joint purchase system according to an embodiment of the present invention. This material joint purchase system is utilized among company ∘∘xx, company A, company B and company C to be material purchasing companies, and contract information with suppliers which the respective companies have contracts with is managed by company ∘∘xx.

In case that plural material purchasing companies purchase the same article from the same supplier, they can obtain information of the unit price, transaction unit and the like of the article from collected contract information, select the most inexpensive contract condition and then purchase the article. For example, in case that company A has a transaction contract of paint of a specific color with a supplier and company ∘∘xx also purchases the same as the paint purchased by company A, if an article unit price of company ∘∘xx is cheaper in comparing an article unit price based on the contract of company A and the article unit price of company ∘∘xx with each other, company B, company C and additionally company A select the contract information of company ∘∘xx and purchase the paint being a material to be purchased through the route of company ∘∘xx from the supplier.

The orders from company A, company B and company C are registered at a server 4A of company ∘∘xx, and company ∘∘xx which has received these orders searches its own material management database 4B and checks where the corresponding material to be purchased is in stock, and if it is in stock, immediately distributes the material to be purchased through its own distribution route R. In case that it is not in stock, company ∘∘xx orders the material from the supplier and has the supplier deliver the material to the place of delivery based on a contract with the supplier, and after this, distributes the material to companies A to C which have ordered the material to be purchased through its own distribution route R.

Also in case that another company has a more advantageous contract condition, nearly the same manner is performed.

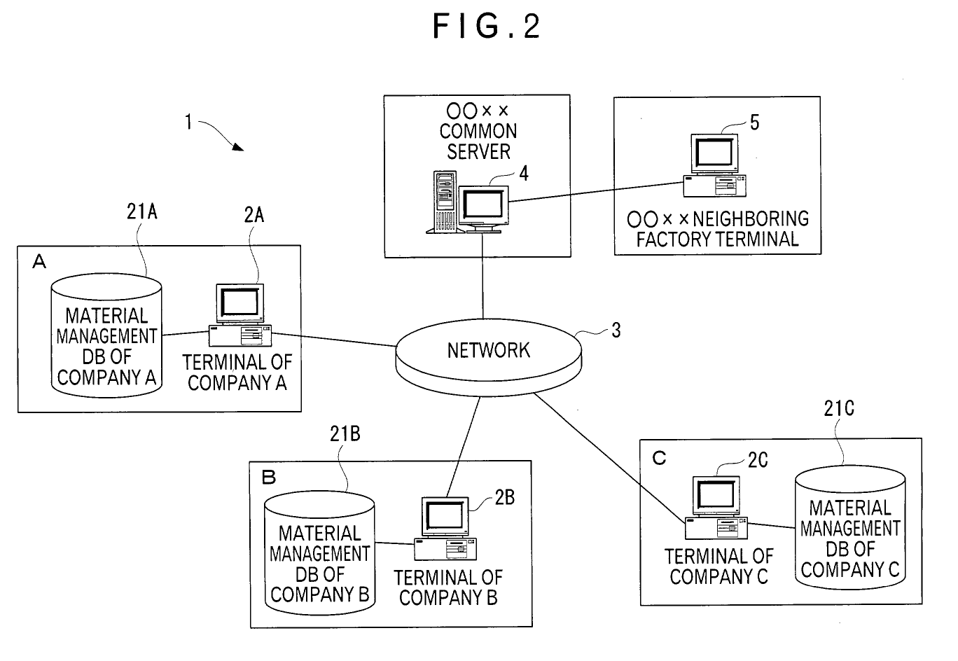

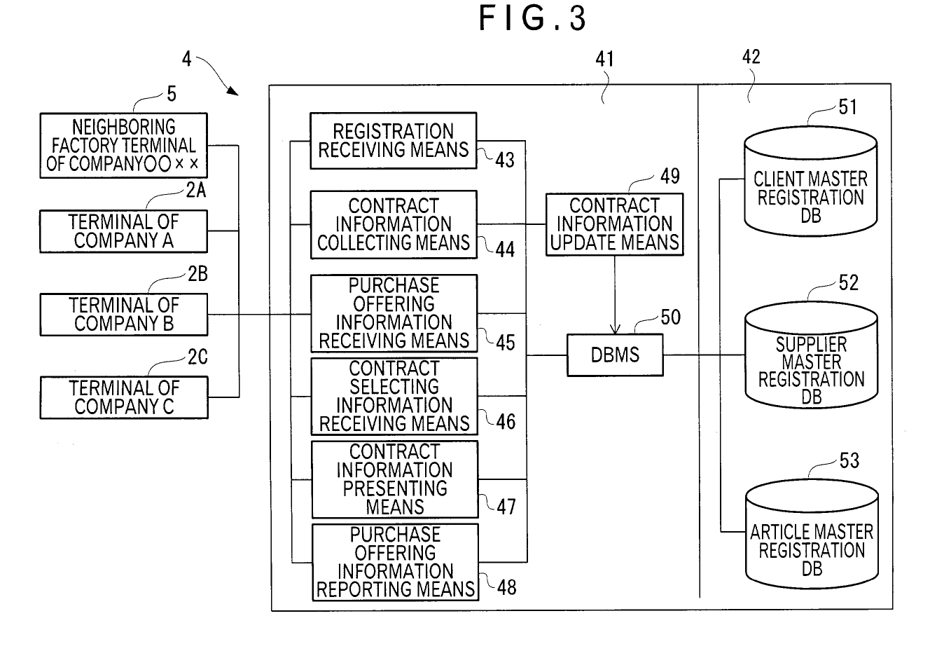

FIG. 2 shows a system configuration for realizing the above-described business model on a network, and this material joint purchase system 1 comprises terminals 2A, 2B and 2C, a network 3, a common server 4, and a factory terminal 5.

Terminals 2A, 2B and 2C are respectively terminal computers possessed by company A, company B and company C participating in a material joint purchase system 1, and each of them comprises an arithmetic unit and a storage unit although not illustrated, and has a browser installed as software.

And the respective terminals 2A, 2B and 2C are made so as to be connectable, respectively, to material management databases 21A, 21B and 21C of the respective companies, and each of them comprises a material management information output means for outputting material management information related to a material to be purchased in the material management database 21A, 21B or 21C to the common server 4 through the network 3.

The network 3 is composed as the Internet conforming to a protocol such as TCP/IP and the like, and contract information to be presented by the common server 4 is presented as a site in the form of HTML or the like on the World Wide Web (WWW).

The factory terminal 5 is a terminal possessed by a factory of company ∘∘xx administering this material joint purchase system 1, and is composed as a terminal computer in case of receiving a stock delivery instruction from the common server 4 and being used when the factory purchases a material for itself utilizing the material joint purchase system 1. This factory terminal 5 has a similar composition to terminals 2A and 2B, and is connected not through the network 3 but through an intranet built within company ∘∘xx to the common server 4.

The common server 4 is composed as a computer comprising an arithmetic unit 41 and a storage unit 42, and although not illustrated, this common server 4 has an input device such as a keyboard, mouse and the like, and an output device such as a display, printer and the like connected to it.

This common server 4 comprises a registration receiving means 43, a contract information receiving means 44, a purchase offering information receiving means 45, a contract selecting information receiving means 46, a contract information presenting means 47, a purchase offering information reporting means 48, a contract information update means 49 and a database management means 50. Each of means 43 to 50 is made as a program which is invoked and operated by the OS (Operating System) controlling operation of the whole server including the arithmetic unit 41 according to need.

And the storage unit 42 has a client master registration database 51, a supplier master registration database 52 and an article master registration database 53 secured on it, and can perform storage, retrieval and the like of data by means of the database management means 50 utilizing language SQL.

The registration receiving means 43 is a portion which accesses the common server 4 by operating terminals 2A, 2B or 2C, receives a participation request of a client attempting to participate in the material joint purchase system 1, namely, company A, company B or company C being a material purchasing company, and collects master data of the relevant client.

Although described in detail later, this registration receiving means 43 returns a client information registration screen to terminal 2A, 2B or 2C to prompt input and transmission of client information in response to a participation request sent from terminal 2A, 2B or 2C. Client information to be collected includes an approval authorizer determining whether or not the purchase of materials is to be approved and the like in addition to the name, address and telephone number of a client.

When this registration receiving means 43 collects client information, it determines and returns an identification code and a password to terminal 2A, 2B or 2C, associates the identification code and password with the collected client information, and records and stores the associated client information through the database management means 50 into the client master registration database 51.

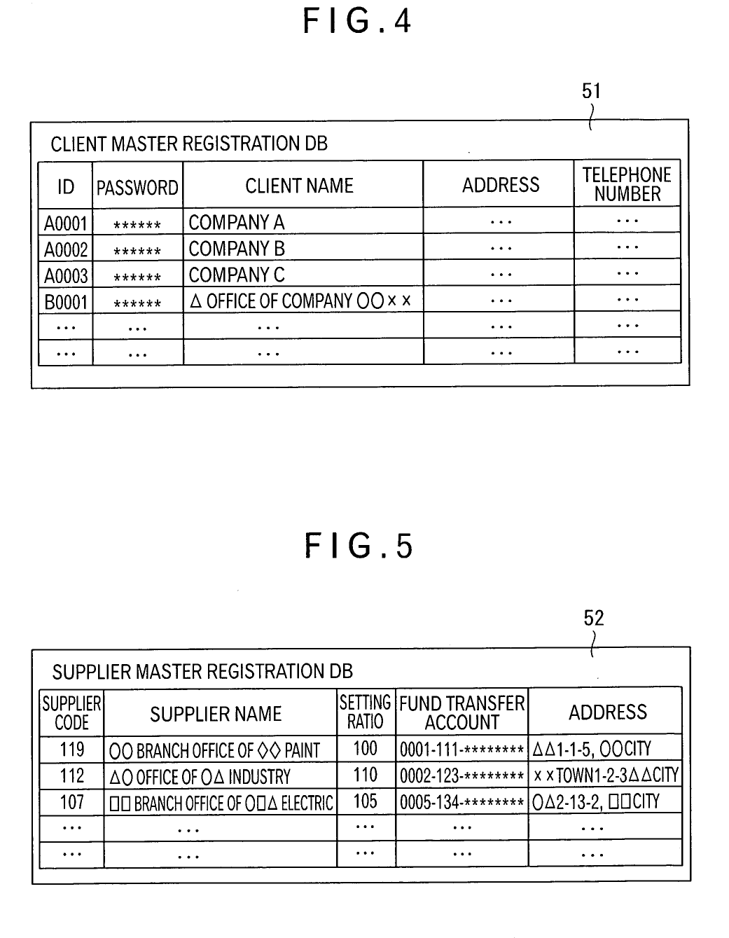

The client master registration database 51 is a portion in which client information is stored, and is composed as a database of a table structure in which one recording table is set as shown in FIG. 4, and this client master registration database 51 has the identification code, password, name, address and the like of a client stored in it as one record.

The contract information collecting means 44 is a portion which collects contract information of company A, company B and company C each being a material purchasing company registered as a member with suppliers. The contract information includes supplier information related to a supplier which each of companies A, B and C being material purchasing companies has a contract with and article information related to an article related to the contract with the supplier, and the contract information collecting means 44 collects supplier information and article information in order.

The supplier information is composed of information including a supplier name, setting ratio, fund transfer account, address and the like, and the contract information collecting means 44 sends a screen for prompting input of these information to terminals 2A, 2B and 2C, obtains necessary information and then determines a maker code and associates the maker code with the obtained information, and records and stores these information in the supplier master registration database 52 through the database management means 50.

The supplier master registration database 52 is a portion in which supplier information is stored and is composed as a database of a table structure in which one recording table is set as shown in FIG. 5, and this supplier master registration database 52 has the maker code, supplier name, setting ratio, fund transfer account, address and the like of a supplier recorded in one record.

On the other hand, the article information is composed to include an item number, maker code, item name, purchase unit price, transaction unit and the like, and the contract information collecting means 44 sends a screen for prompting input of these information to terminals 2A, 2B and 2C after it has collected the supplier information. As the maker code, a maker code determined by input of the supplier information is displayed by default in a state uncontrollable by terminal 2A, 2B or 2C. And the item number to be inputted on the screen of terminal 2A, 2B or 2C may be an item number determined by the supplier.

After obtaining necessary information, the contract information collecting means 44 converts the item number into a unique item number code in the system and then associates the item number code with the information of the maker code, item name, purchase unit price and the like, and records and stores these information into the article master registration database 53 through the database management means 50.

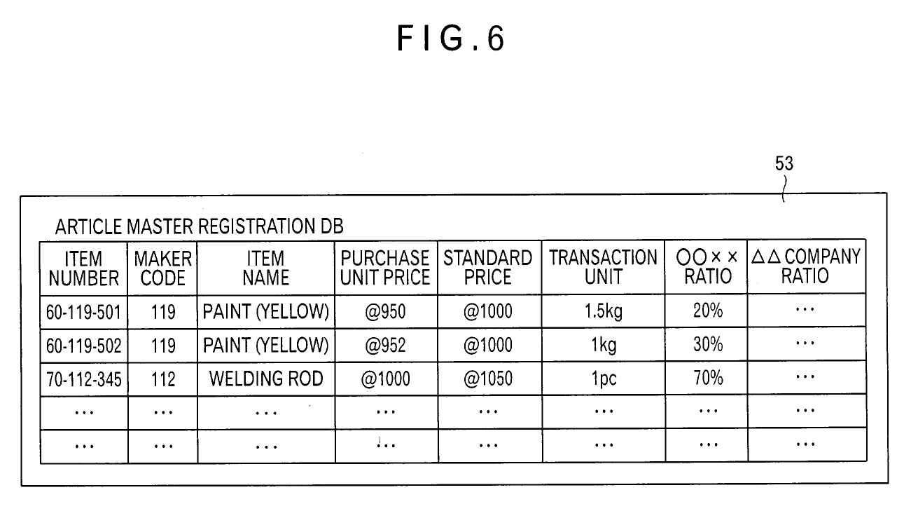

The article master registration database 53 as a contract information storing means is a portion in which contract information including a purchase unit price and a transaction unit is stored, and is composed as a database of a table structure in which one recording table is set as shown in FIG. 6, and this article master registration database 53 has an item number, maker code, item name, purchase unit price, standard price, transaction unit and the like recorded in one record.

An item number in FIG. 6 is based on conversion by the contract information collecting means 44, and this example performs the conversion of connecting an article kind, a maker code and a collected item number determined by a supplier to each other with a hyphen between them. And contract information with the same supplier related to the same article is inputted by the contract information collecting means 44 from each of companies A, B and C being plural material purchasing companies, the respective pieces of contract information themselves are recorded as separate records, and the ratio of transactions of each material purchasing company related to the same article is recorded at the end of each record.

The purchase offering information receiving means 45 is a portion receiving a purchase offering information outputted from each of terminals 2A, 2B and 2C, and purchase offering information includes a maker name, article name, item number, necessary amount and the like. The received purchase offering information is outputted to the database management means 50.

The database management means 50 searches the article master registration database 53 on the basis of this information, extracts contract information related to the relevant item number and outputs the result of extraction to the contract information presenting means 47.

The contract information presenting means 47 is a portion presenting the extracted contract information to each of terminals 2A, 2B and 2C, and the contract information to be presented is generated by adding time limit information such as the time limit of delivery and the like to each of the results extracted by the database management means 50. And the contract information presenting means 47 outputs and transmits the plural generated pieces of contract information in the form of a table to terminals 2A, 2B and 2C.

The contract selecting information receiving means 46 is a portion receiving contract information selected as a desired material purchase route by operation of terminal 2A, 2B or 2C out of contract information presented on the display screen of terminal 2A, 2B or 2C, and the received contract selecting information is outputted to the purchase offering information reporting means 48.

The purchase offering information reporting means 48 is a portion reporting a purchase offer to company A, company B, company C or company ∘∘xx being a material purchasing company having the selected contract.

Concretely, the purchase offering information reporting means 48 generates as a sequence of information a maker name, an article name, an item number, a necessary amount and a delivery time limit to be included in purchase offering information, and if the selected contract belongs to company A, company B or company C, it outputs and transmits this information to terminal 2A, 2B or 2C to be responded to.

On the other hand, if the selected contract belongs to company ∘∘xx, it outputs and transmits said information to a factory terminal 5 of a neighboring factory located in the neighborhood of a material purchase offering company and purchasing the relevant item number.

Each company or the neighboring factory gives a supplier an order for an article of the amount obtained by adding the amount of transaction of the purchase offering information to its own ordinary amount of transaction, and after the article is delivered, it distributes the article to the material purchase offering company by means of its own distribution route.

The contract information update means 49 is a portion updating stored contract information in case of changing a contract condition with the increase in amount of ordered material as a result of establishment of material joint purchase in a form as described above. Contract update information related to the update of contract information is outputted from each of terminals 2A, 2B and 2C, and is temporarily received by the contract information collecting means 44, and then information stored in the article master registration database 53 through the database management means 50 is updated by the contract information update means 49.

Hereupon, in case that company A, company B or company C changes a contract with a supplier, an employee of it may operate a terminal of it to output the content of change to the common server 4, and since terminals 2A, 2B or 2C is respectively connected to the material management databases 21A, 21B or 21C, it may output contract update information by means of this. Concretely, a material management information output means monitors contract information related to articles stored in the material management databases 21A, 2B or 2C and registered at the common server 4, and when contract information is changed, it outputs the content of change as contract update information.

[Operation of the System]

Next, operation of the above-mentioned material joint purchase system is described with reference to flowcharts.

1. Registration of Client Information and Contract Information

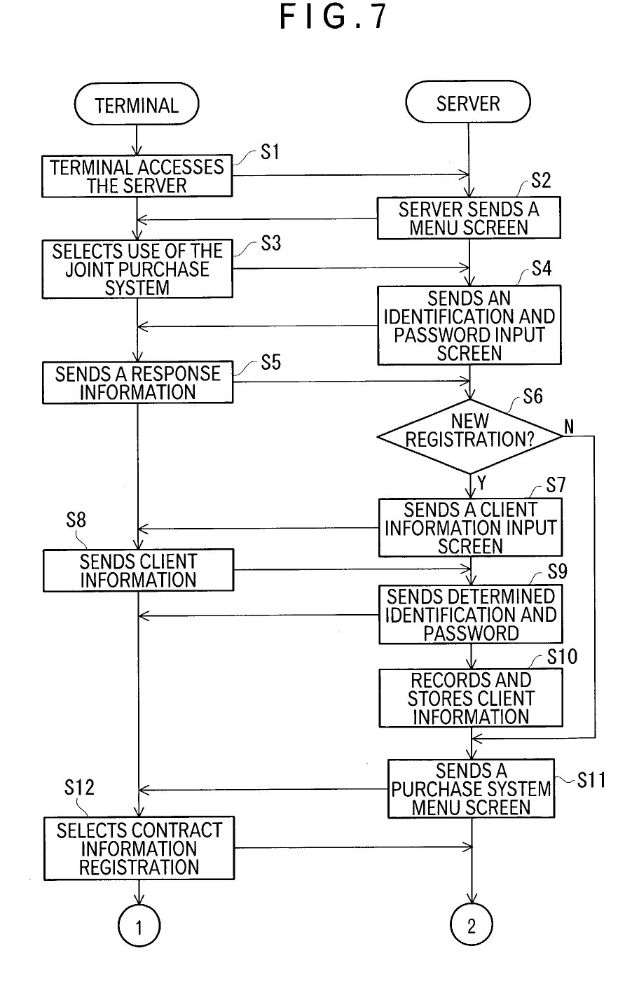

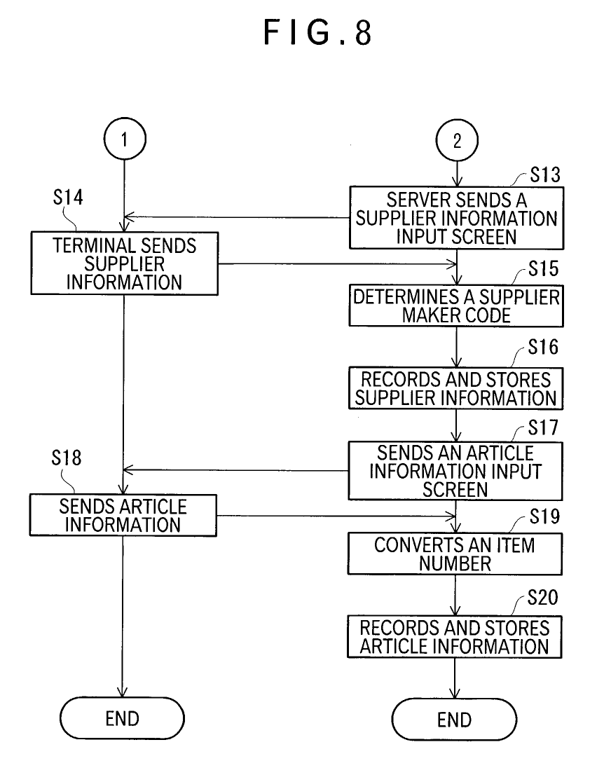

Registration of client information and contract information is performed on the basis of flowcharts shown in FIGS. 7 and 8.

(1) First, when a user operates terminal 2A, 2B or 2C to access the common server 4 by means of a browser (step S1), the common server 4 sends a system use menu screen to prompt selection of a system to be used (step S2).

(2) When the user sends information that it has selected a material joint purchase system 1 through terminal 2A, 2B or 2C (step S3), the registration receiving means 43 sends an identification code and password input screen to terminal 2A, 2B or 2C to prompt input of an identification code and a password (step S4).

(3) When response information is sent from terminal 2A, 2B or 2C (step S5), the registration receiving means 43 judges whether or not it is a new registration (step S6).

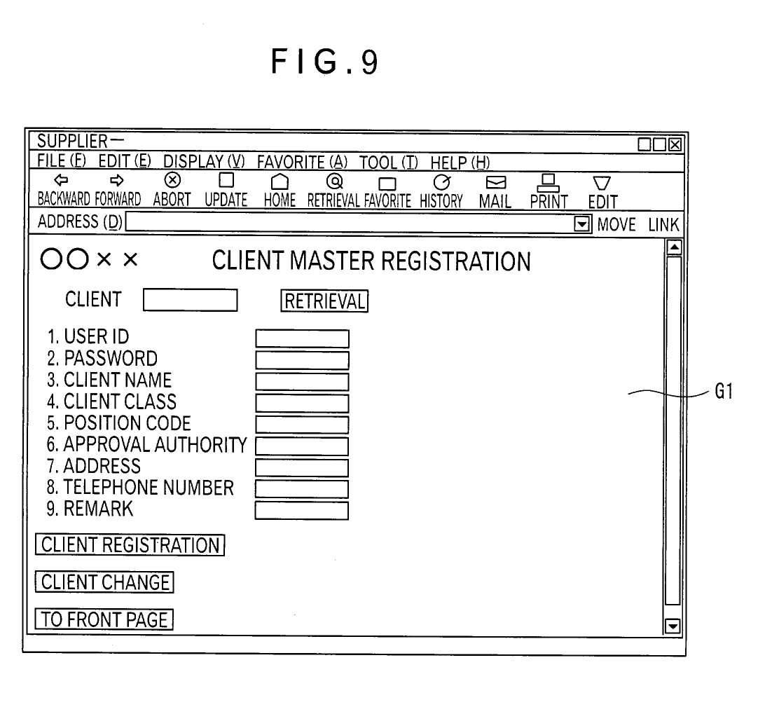

(4) In case that the response information is information of a new registration, the registration receiving means 43 sends a client master registration screen GI shown in FIG. 9 to terminal 2A, 2B or 2C to prompt input of client information (step S7).

(5) When client information having necessary matters inputted into the screen G1 is sent from terminal 2A, 2B or 2C (step S8), the registration receiving means 43 determines an identification code and a password for the relevant client and sends the determined identification code and password to terminal 2A, 2B or 2C (step S9), and records and stores the collected client information into the client master registration database 51 through the database management means 50 (step S10).

(6) When the registration is ended, the common server 4 sends a menu screen of the material joint purchase system 1 to terminal 2A, 2B or 2C (step S11). In case that the user has been already registered as a member, the common server 4 skips the above-described steps (4) and (5), and sends the menu screen of the material joint purchase system 1 to terminal 2A, 2B or 2C (step S11).

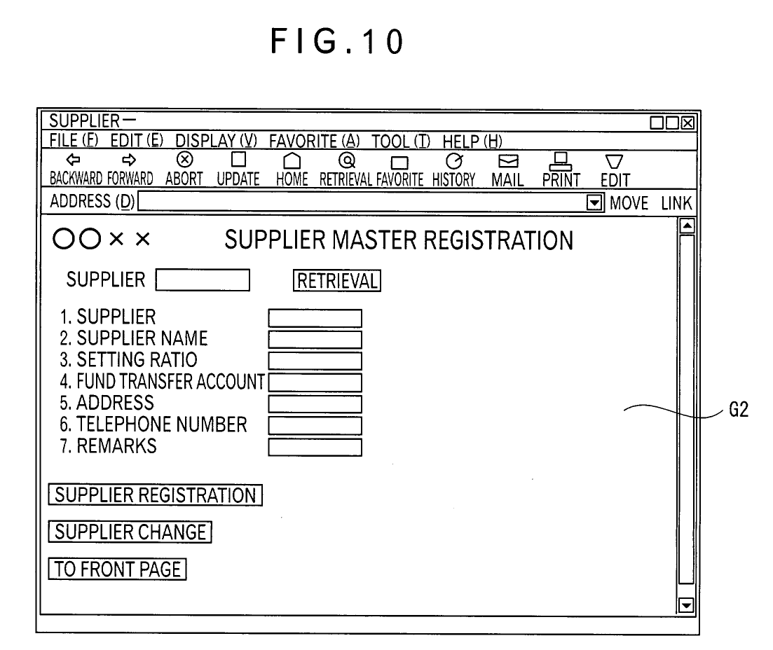

(7) When information of selecting a contract information registration menu is sent from terminal 2A, 2B or 2C (step S12), the contract information collecting means 44 first sends a supplier master registration screen G2 shown in FIG. 10 to prompt input of supplier information related to the contract information to be registered (step S13).

(8) When supplier information based on the screen G2 is sent from terminal 2A, 2B or 2C (step S14), the contract information collecting means 44 determines a maker code (step S15) and associates the maker code and the collected supplier information with each other, and then records and stores this information into the supplier master registration database 52 through the database management means 50 (step S16).

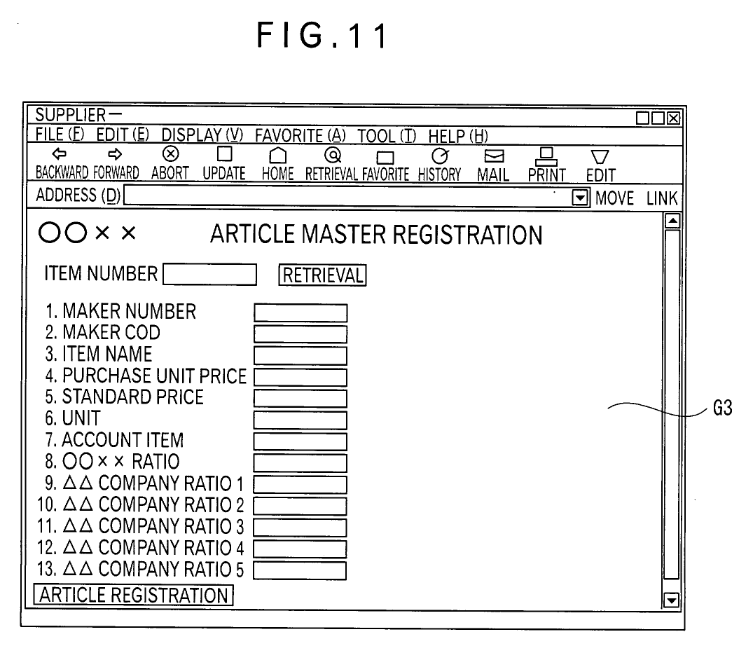

(9) When the supplier information is recorded and stored, the contract information collecting means 44 sends an article master registration screen G3 shown in FIG. 11 to terminal 2A, 2B or 2C to prompt input of article information related to contract information to be registered (step S17: contract information collecting step).

(10) When article information based on the screen G3 is sent from terminal 2A, 2B or 2C (step S18), the contract information collecting means 44 ties the maker code, the article kind and the item number of the article in this order through a hyphen to one another to convert the item number code (step S119) and associates the converted item number code and the obtained article information with each other, and then records and stores this information into the article master registration database 53 through the database management means 50 (step S20: contract information storing step).

2. Joint Purchase of Materials

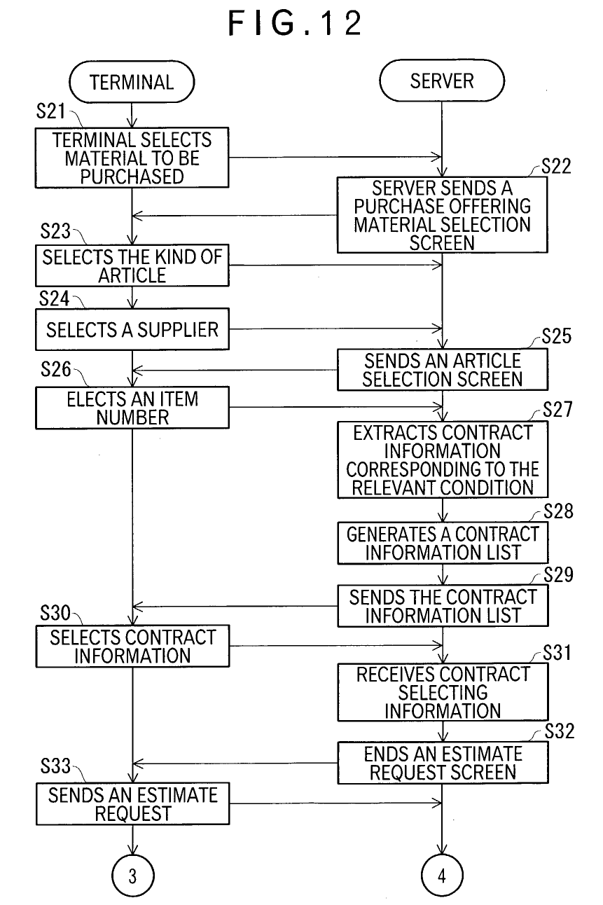

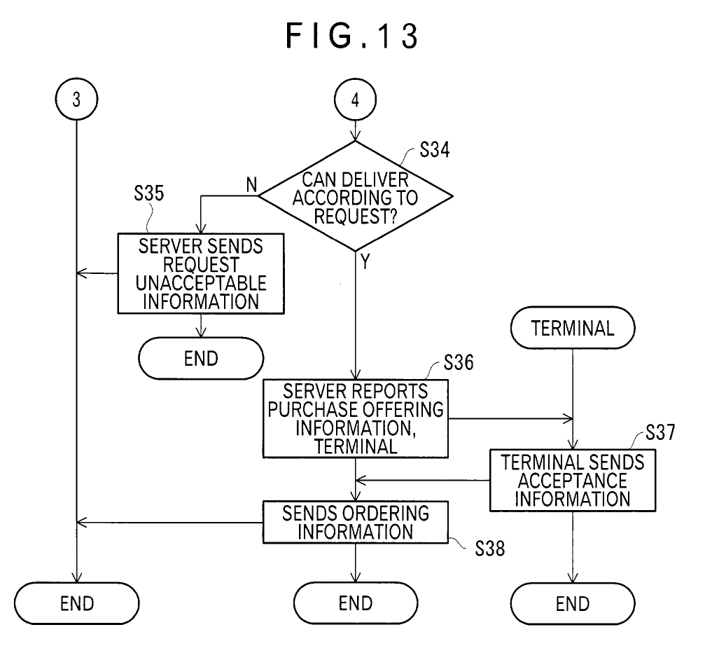

Joint purchase of materials is performed on the basis of flowcharts of FIGS. 12 and 13.

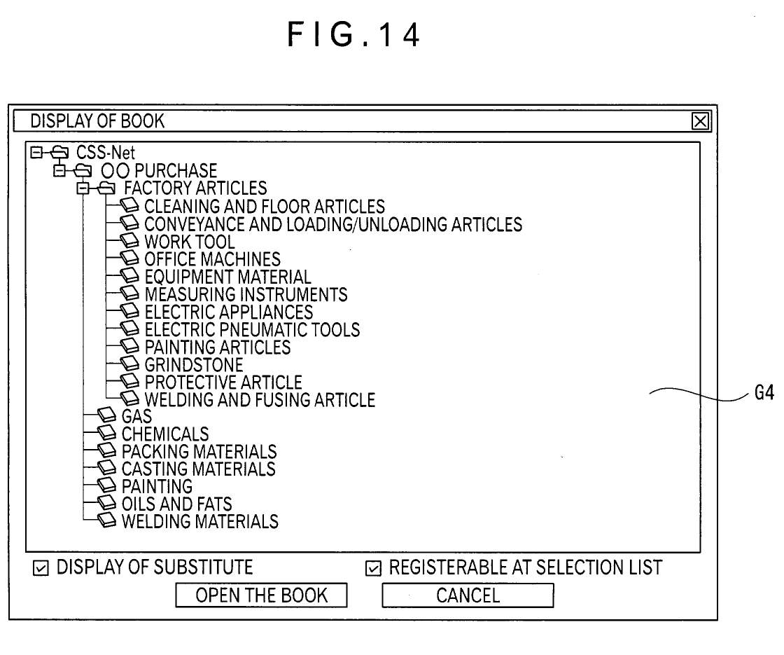

(1) In a menu screen of a material joint purchase system 1 after steps (1) to (5) in registration of client information and contract information as described above, when information that a material purchase offering menu has been selected is sent from terminal 2A, 2B or 2C to the common server 4 (step S21), the purchase offering information receiving means 45 sends a material selection screen G4 shown in FIG. 14 to terminal 2A, 2B or 2C to prompt selection by terminal 2A, 2B or 2C (step S22). This selection screen G4 can be displayed hierarchically utilizing item number codes in FIG. 6. That is to say, this item number code is composed in the form of (article)-(maker code)-(article item number), and when an article is selected on the screen G4, a list of suppliers supplying the relevant article is displayed.

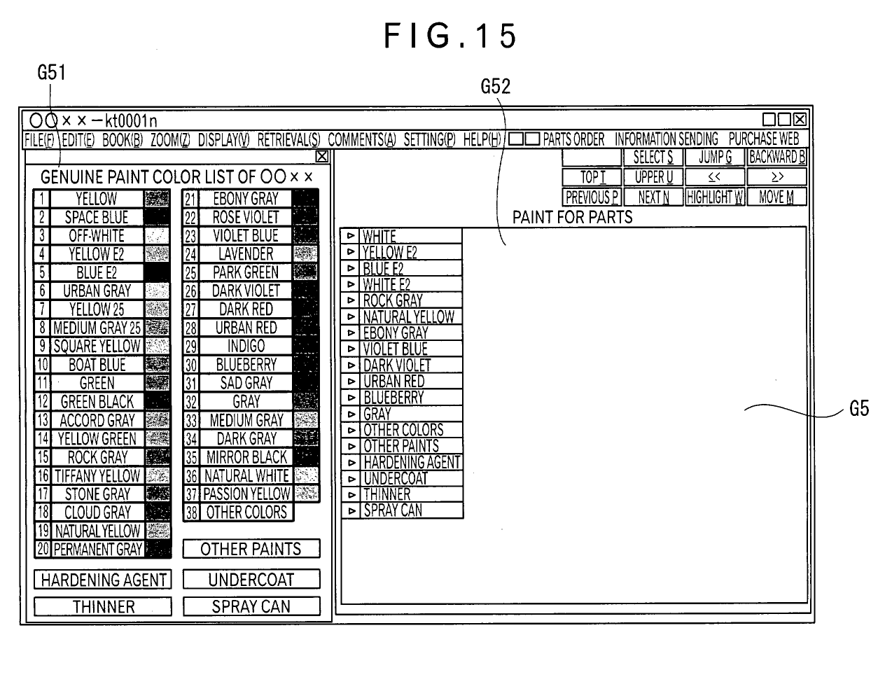

(2) When an article kind is selected by terminal 2A, 2B or 2C (step S23) and further a supplier is selected (step S24), and information of the above steps is sent to the common server 4, the purchase offering information receiving means 45 sends an article selection screen G5 shown in FIG. 15 to terminal 2A, 2B or 2C (step S25). Hereupon, this article selection screen G5 is divided into two sub-screens G51 and G52, and when a desired color is selected on the sub-screen 51, pieces of information further subdivided in response to this are displayed on the sub-screen 52.

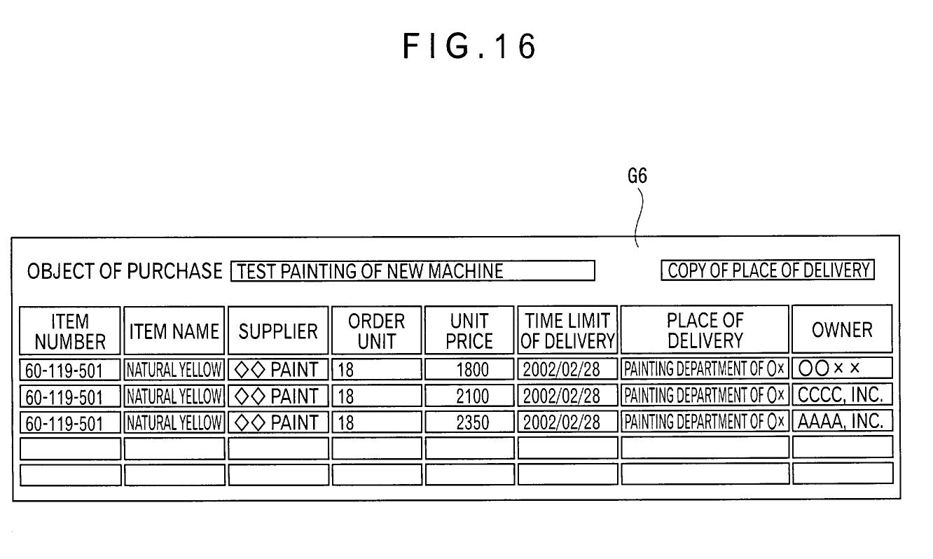

(3) When information that an item number has been selected on the article selection screen G5 is sent by terminal 2A, 2B or 2C (step S26), the purchase offering information receiving means 45 outputs the item number to the database management means 50, and the database management means 50 extracts a relevant contract condition from the article master registration database 53 (step S27). The extracted contract information is outputted to the contract information presenting means 47, and the contract information presenting means 47 generates a contract information list as shown in FIG. 16 on the basis of the result of extraction (step S28) and sends this list to terminal 2A, 2B or 2C (step S29: contract information presentation step). In case that its own contract condition is judged to be more advantageous in confirmation of the presented contract information list on terminal 2A, 2B or 2C, the selection may be aborted or an operation of registering its own contract information may be performed according to the above-described steps.

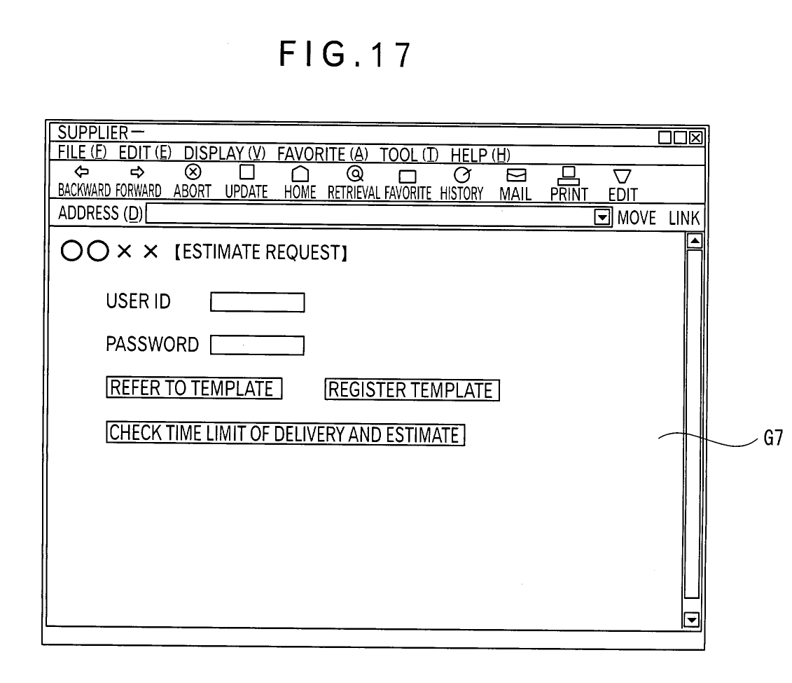

(4) In screen G6, when a user operates terminal 2A, 2B or 2C to move a cursor to a piece of contract information presented in the contract information list and operates an estimate request button not illustrated in FIG. 6, contract selecting information is sent from terminal 2A, 2B or 2C to the common server 4 (step S30). The contract selecting information sent is received by the contract selecting information receiving means 46 (step S31: contract selecting information receiving step), and the contract selecting information receiving means 46 sends an estimate request screen shown in FIG. 17 (step S32).

(5) When information of requesting estimate is sent from terminal 2A, 2B or 2C on the basis of screen G7 (step S33), this information is processed by the purchase offering information reporting means 48. The purchase offering information reporting means 48 searches the article master registration database 53 by means of the database management means 50 to judge whether or not the article can be delivered according to the request (step S34).

(6) As the result of judgment, if it has been judged that the article cannot be delivered according to the request, the purchase offering information reporting means 48 sends request unacceptable information of being unable to meet the request to terminal 2A, 2B or 2C (step S35) and ends the system.

(7) In case that the article can be delivered according to the request, the purchase offering information reporting means 48 outputs and transmits information of an item number, the amount of article to be purchased, the time limit of delivery, an amount of money and the like to terminal 2A, 2B or 2C of company A, company B or company C each having a material purchase contract (step S36: purchase offering information reporting step).

(8) When the purchase offering information is sent to terminal 2A, 2B or 2C of company A, company B or company C related to the contract selecting information, an operation of giving an order for the material is performed utilizing a terminal of the relevant company and order acceptance information is sent from the terminal to the common server 4 (step S37). When the order acceptance information is received by the common server 4, the common server 4 sends ordering information that the ordering operation has been ended to terminal 2A, 2B or 2C (step S38) and ends the material joint purchase system 1.

3. Update of Contract Information

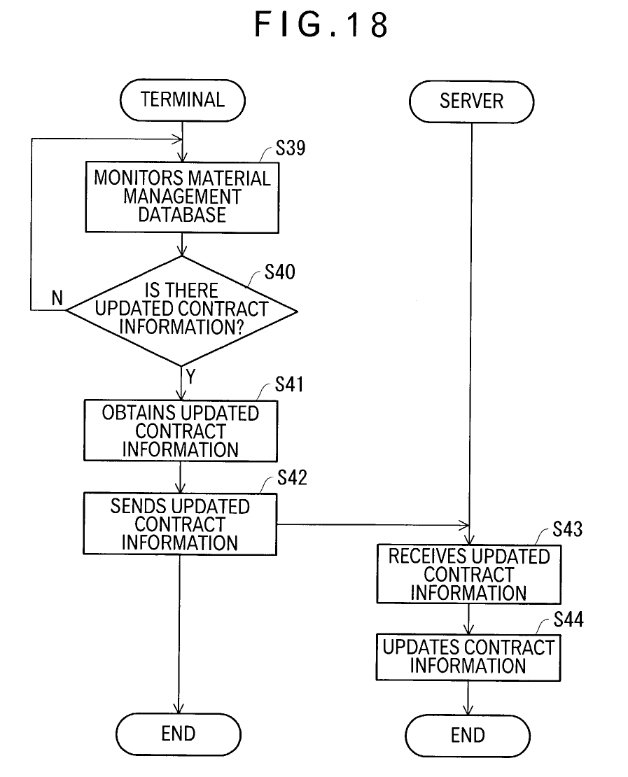

In case that the joint purchase as described above is performed and contract information is reexamined and contract information of the material joint purchase system 1 is updated, these operations are performed on the basis of a flowchart shown in FIG. 18.

(1) A material management information output means of terminal 2A, 2B or 2C of company A, company B or company C each having a contract with a supplier periodically monitors contract information related to purchase of materials from the supplier stored in a material management database 21A, 21B or 21C respectively connected to these terminals (step S39), and judges whether or not the contract information is updated (step S40).

(2) When the contract information is judged to be updated, the material management information output means obtains the updated contract information from the material management database 21A, 2B or 2C (step S41), and sends the updated contract information obtained to the common server 4 (step S42).

(3) The sent contract information is received by the contract information collecting means 44 of the common server 4 (step S43), is converted into the data format of the material joint purchase system 1 and thereafter is outputted to the contract information update means 49.

(4) The contract information update means 49 searches the article master registration database 53 on the basis of the item number of an article contained in the updated contract information by means of the database management means 50, compares both the data, changes information of the updated part, for example, the purchase unit price, transaction unit and the like, and updates the information recorded in the article master registration database 53 (step S44).

The following effects are obtained by performing a material joint purchase method by means of a material joint purchase system 1 according to such a sequence of processing steps.

First, a company offering to purchase a material can purchase the material through a purchase route being the lowest in purchase unit price in a list presented on screen GI 6 of FIG. 16. Therefore, a route being higher in purchase unit price than that purchase route is naturally weeded out, and routes for purchasing a material from a supplier can be unified.

As a result, a material purchasing company is made easy to request a supplier to lower a purchase unit price with the increase in amount of ordered material in the relevant purchase route, and further by updating contract information to the contract information being made lower in purchase unit price, it is made possible to purchase the material at a lower price.

And since a material joint purchase system 1 of this embodiment adopts a method of membership registration, it is possible to obtain credit information of a company desiring to participate in the system and thereby secure proper transactions.

Furthermore, thanks to concentration of orders, a supplier can simplify its distribution route and reduce sharply the cost of distribution in supplying articles.

The present invention is not limited to the above-described embodiment, but includes variations as described in the following.

Although means 43 to 50 and databases 51 to 53 forming the present invention are arranged inside a single common server 4, the present invention is not limited to this. That is to say, a plurality of servers may cooperate with one another and the respective means may perform collection, storage, retrieval and the like of information on separate servers.

And although the above-described embodiment is composed so that material management information is outputted from terminal 2A, 2B or 2C, the present invention is not limited to this. That is to say, the system may be composed so that a common server monitors round the material management databases in order through terminals.

Furthermore, although in the above-described embodiment terminals 2A, 2B and 2C each are made as a terminal dedicated to the material joint purchase system 1, they are not limited to this but these terminals may be used as a material management database control means by being provided with an accounting function.

In addition, as a concrete structure, processing steps and the like in implementing the present invention, other structures and the like may be adopted within a scope in which the object of the invention can be attained.

What is claimed is:

1. A material joint purchase system being provided with terminals (2A, 2B and 2C) respectively possessed by a plurality of material purchasing companies and a server connected to each of the terminals (2A, 2B and 2C) through a network 3 and enabling the plurality of material purchasing companies to jointly purchase materials from material suppliers, comprising;
a contract information collecting means (44) for collecting contract information related to material purchase contracts which each of the material purchasing companies has with said material suppliers,
a contract information storing means (53) for storing the collected contract information according to the kind of material being a contract object,
a contract information presenting means (47) for presenting stored contract information to said terminal (2A, 2B or 2C) in response to material purchase offering information outputted from said terminal (2A, 2B or 2C),
a contract selecting information receiving means (46) for receiving contract selecting information selected out of presented contract information, and
a purchase offering information reporting means (48) for reporting said purchase request information to a terminal of a material purchasing company having a material purchase contract related to the received contract selecting information.

2. A material joint purchase system according to claim 1, further comprising;
a contract information update means (49) for collecting information related to change in a material purchase contract on the basis of a result of material transactions of a material purchasing company notified of said purchase offering information and updating contract information stored in said contract information storing means (53).

3. A material joint purchase system according to claim 1, wherein;
contract information stored in said contract information storing means includes at least the item number, the price and the place of delivery of said material.

4. A material joint purchase system according to claim 1, wherein;
the terminals (2A, 2B and 2C) are respectively connected to the material management information storing means (21A, 21B and 21C) storing material management information of the respective material purchasing companies and are provided with material management information output means for outputting material management information stored in said material management information storing means to said server 4.

5. A material joint purchase method being performed between terminals (2A, 2B and 2C) respectively possessed by a plurality of material purchasing companies and a server connected to each of the terminals (2A, 2B and 2C) through a network 3 and enabling the plurality of material purchasing companies to jointly purchase materials from material suppliers, comprising;
a contract information collecting step (S17) of making a computer collect contract information related to material purchase contracts which each of the material purchasing companies has with said material suppliers,
a contract information storing step (S20) of making a computer store the collected contract information according to the kind of material being a contract object,
a contract information presenting step (S29) of making a computer present stored contract information to said terminal (2A, 2B or 2C) in response to material purchase offering information outputted from said terminal (2A, 2B or 2C),
a contract selecting information receiving step (S31) of making a computer receive contract selecting information selected out of presented contract information, and
a purchase offering information reporting step (S36) of making a computer report said purchase offering information to a terminal (2A, 2B or 2C) of a material purchasing company having a material purchase contract related to the received contract selection information.

6. A program for making a computer perform a material joint purchase method being performed between terminals (2A, 2B and 2C) respectively possessed by a plurality of material purchasing companies and a server connected to each of the terminals (2A, 2B and 2C) through a network 3 and enabling the plurality of material purchasing companies to jointly purchase materials from material suppliers, said program making the computer perform;
a contract information collecting step (S17) of collecting contract information related to material purchase contracts which each of the material purchasing companies has with said material suppliers,
a contract information storing step (S20) of storing the collected contract information according to the kind of material being a contract object,
a contract information presenting step (S29) of presenting stored contract information to said terminal (2A, 2B or 2C) in response to material purchase offering information outputted from said terminal (2A, 2B or 2C),
a contract selecting information receiving step (S31) of receiving contract selecting information selected out of presented contract information, and
a purchase offering information reporting step (S36) of reporting said purchase offering information to a terminal (2A, 2B or 2C) of a material purchasing company having a material purchase contract related to the received contract selecting information.
